(19) United States
(12) Patent Application Publication
(10) Pub. No.: US 2020/0204087 A1
(43) Pub. Date: Jun. 25, 2020

(54) POWER GENERATION SYSTEM AND PORTABLE WATCH

(71) Applicant: CITIZEN WATCH CO., LTD., Tokyo (JP)

(72) Inventors: Shogo Kimura, Kawasaki-shi (JP); Akira Shiota, Saitama-shi (JP); Makoto Watanabe, Tokorozawa-shi (JP); Akira Izumi, Tokyo (JP)

(73) Assignee: CITIZEN WATCH CO., LTD., Tokyo (JP)

(21) Appl. No.: 16/721,065

(22) Filed: Dec. 19, 2019

(30) Foreign Application Priority Data
Dec. 21, 2018 (JP) 2018-240082

(51) Int. Cl. H02N 1/08; H02J 7/00; H02M 3/158; G04C 10/00

(52) U.S. Cl. CPC H02N 1/08; G04C 10/00; H02M 3/158; H02J 7/0068

(57) ABSTRACT

A power generation system includes a power generation unit, a power storage unit, and a voltage step-down unit. The power generation unit includes a generation main body having an electrification film and a counter electrode rotating relative to each other to generate power, and an energy generator generating energy for rotating the electrification film and the counter electrode. The power storage unit stores output power of the power generation unit. The voltage step-down unit is electrically connected to the power generation unit and the power storage unit and reduces output voltage of the power generation unit to a step-down voltage. The step-down voltage obtained by dividing the most energy-efficiently generated output voltage of the power generation unit by a step-down ratio of the voltage step-down unit coincides with storage voltage corresponding to a region between first and second turning points on a discharge curve of the power storage unit.

### CROSS-REFERENCE TO RELATED APPLICATION(S)

The present application claims priority to and incorporates by reference the entire contents of Japanese Patent Application No. 2018-240082 filed in Japan on Dec. 21, 2018.

### BACKGROUND OF THE INVENTION

### 1. Field of the Invention

The present invention relates to a power generation system and a portable watch.

### 2. Description of the Related Art

Some watches include electromagnetic motors to rotate the hands. To supply energy for driving the electromagnetic motor, watches such as portable watches, or wristwatches worn by users around the wrist, include a power storage unit housed in an outer case of the watch. The power storage unit included in conventional wristwatches is, for example, a rechargeable secondary battery that stores therein the output power of a power generation unit, such as a solar panel, housed in the outer case.

Examples of power generation units that charge the power storage unit in portable watches include electrostatic induction generators (see Japanese Patent Application Laid-open Nos. 2008-161036, 2008-161040, and 2009-219353, for example). The electrostatic induction generators typically include electrification films and counter electrodes that move relative to each other to generate power. The relative movement between the electrification films and the counter electrodes is caused by oscillations generated in the portable watch while the user wearing the watch is moving, or specifically, for example, walking. This configuration allows the electrostatic induction generators to generate power.

Such an electrostatic induction generator outputs a high voltage. To charge the power storage unit with the output of the electrostatic induction generator, such a high voltage has to be reduced by a voltage step-down unit connected to the electrostatic induction generator and to the power storage unit.

If there is a large difference between the voltage output by the power generation unit generating power in most energy-efficient state and the voltage of the power storage unit in storing the output power of the power generation unit, the difference may cause lower charge efficiency in storing the output power in the power storage unit via the voltage step-down unit.

### SUMMARY OF THE INVENTION

The present invention has been made in view of the foregoing, and it is an object of the present invention to provide a power generation system and a portable watch that can efficiently charge a power storage unit with the output of a power generation unit via a voltage step-down unit.

In order to solve the above mentioned problem and achieve the object, a power generation system according to one aspect of the present invention includes a power generation unit including a generation main body that has an electrification film and a counter electrode rotating relative to each other to generate power, and the energy generator that generates energy for rotating the electrification film and the counter electrode relative to each other; a power storage unit configured to store output power of at least the power generation unit; and a voltage step-down unit electrically connected to the power generation unit and the power storage unit and configured to reduce output voltage of the power generation unit to a step-down voltage, wherein the power storage unit has a discharge curve relative to storage voltage and storage capacity, the discharge curve having an inflection point, a first turning point having maximum curvature at a high-voltage side relative to the inflection point, and a second turning point having maximum curvature at a low-voltage side relative to the inflection point, and the step-down voltage obtained by dividing the output voltage of the power generation unit in a rated generation state by a step-down ratio of the voltage step-down unit coincides with storage voltage corresponding to a region between the first turning point and the second turning point of the power storage unit.

In order to solve the above mentioned problem and achieve the object, a portable watch according to another aspect of the present invention includes the power generation system; and a time display unit configured to display time using output of the power storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a portable watch according to an embodiment of the present invention;

FIG. 2 is a sectional view of the portable watch according to the embodiment;

FIG. 3 is a block diagram of a power generation system according to the embodiment;

FIG. 4 is a diagram illustrating a general configuration of a generation main body;

FIGS. 5A and 5B are diagrams for describing the generation operation of the generation main body;

FIG. 6 is a graph illustrating the (averaged) relation between operating frequency of an energy generator and relative rotation rate of an electrostatic induction generator;

FIG. 7 is a graph illustrating the relation between the operating frequency of the energy generator and the relative rotation rate of the electrostatic induction generator;

FIG. 8 is a graph illustrating the relation between output voltage and output current of a power generation unit;

FIG. 9 is a graph illustrating the relation between output voltage and power of the power generation unit;

FIG. 10 is a block diagram of a voltage step-down unit;

FIG. 11 is a diagram for describing the operation of the voltage step-down unit;

FIG. 12 is another diagram for describing the operation of the voltage step-down unit;

FIG. 13 is a graph illustrating a discharge curve of a power storage unit; and

FIG. 14 is a graph illustrating the relation between the input voltage of the power storage unit and the output voltage of the voltage step-down unit.

### DETAILED DESCRIPTION OF THE PREFERRED EMBODIMENT

The following describes an embodiment of the present invention with reference to the accompanying drawings. The embodiment described below is not intended to limit the scope of the present invention. Components of the embodiment below include components that can be easily thought of by the skilled person or components that are substantially the same.

### Embodiment

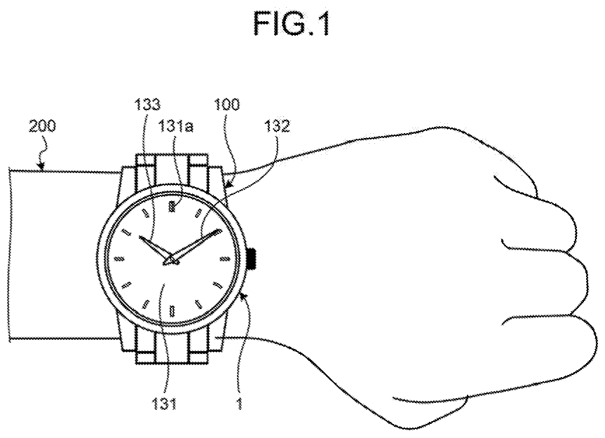

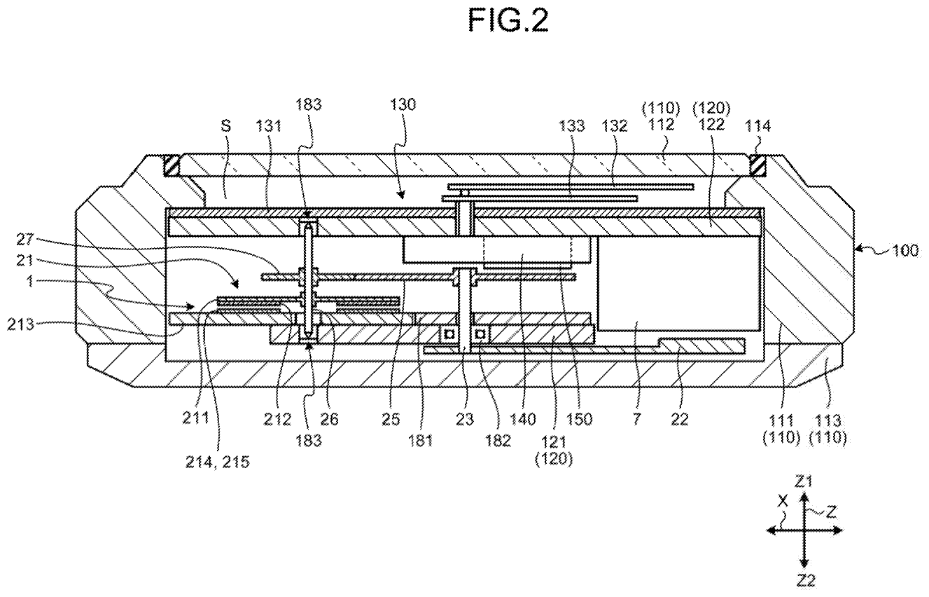

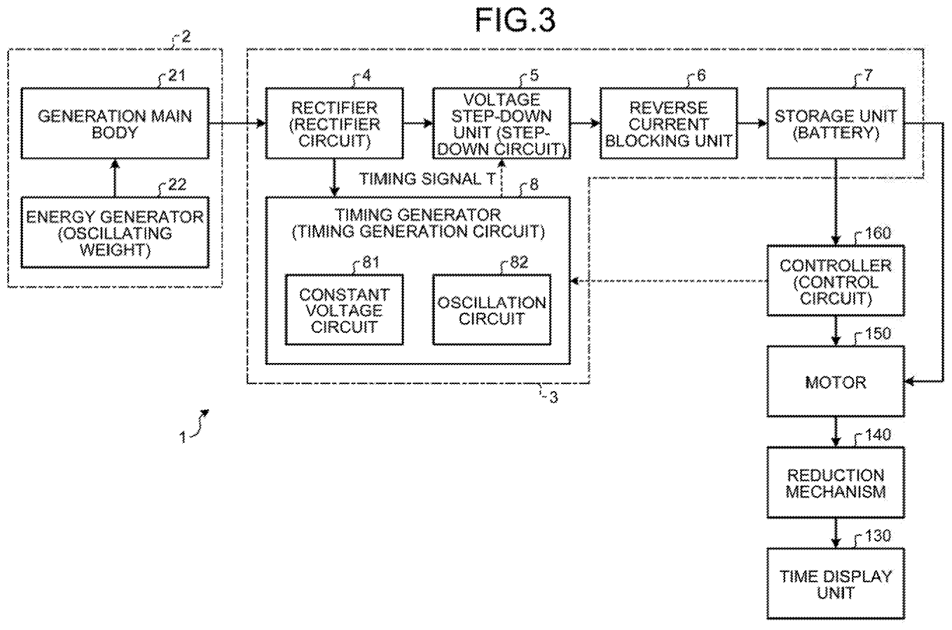

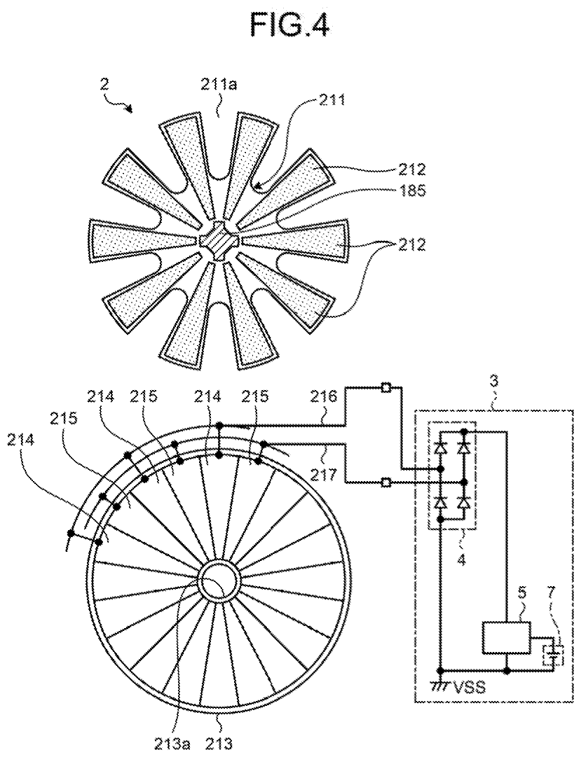

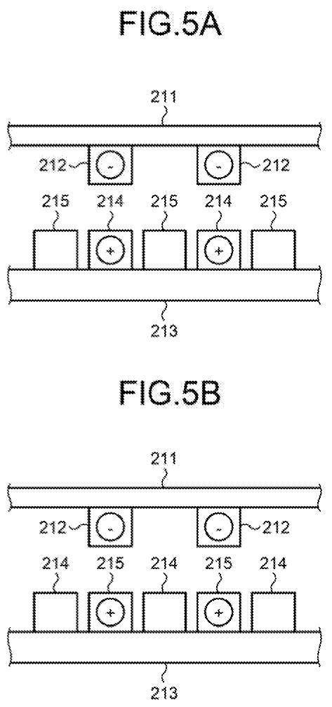

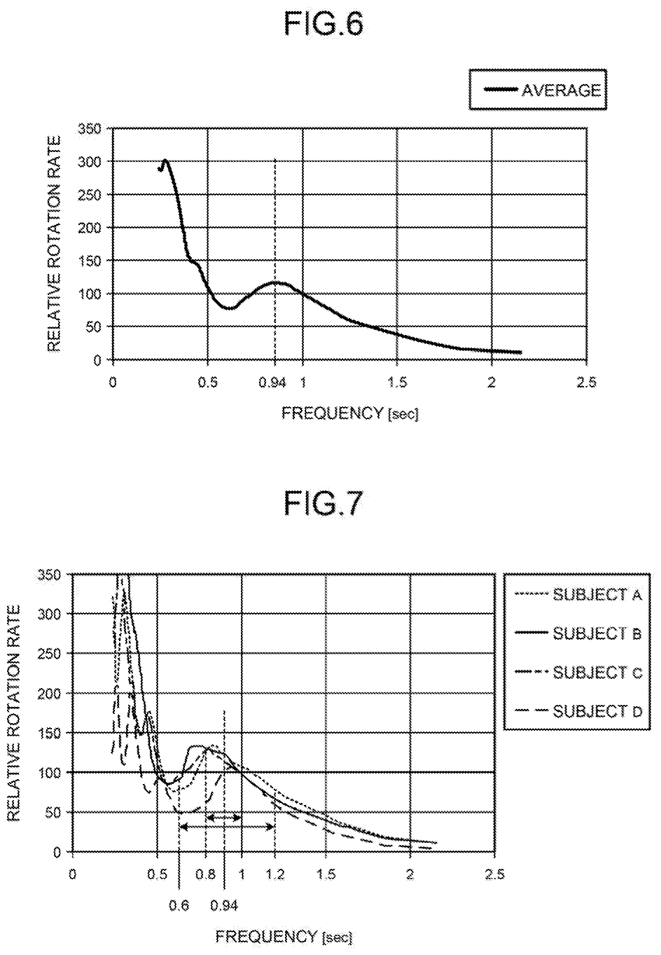

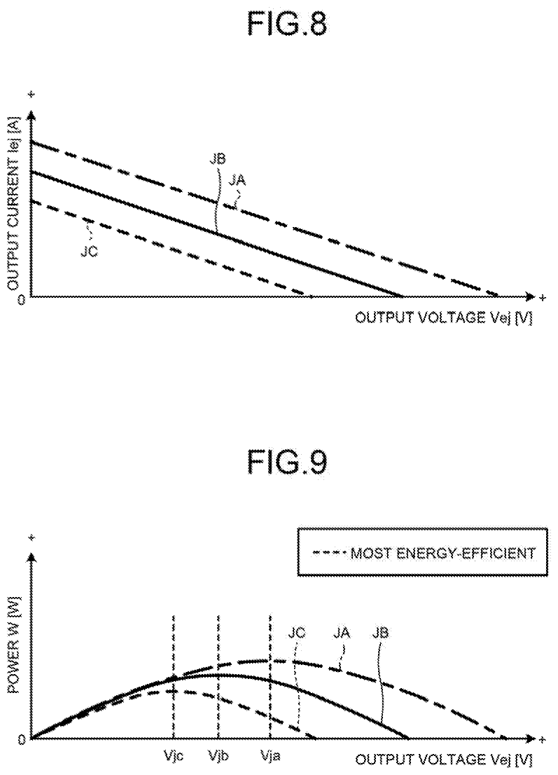

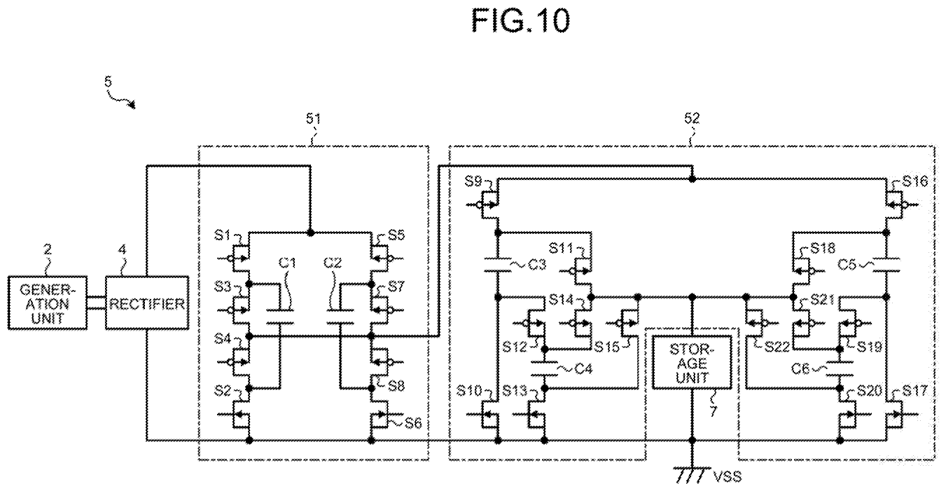

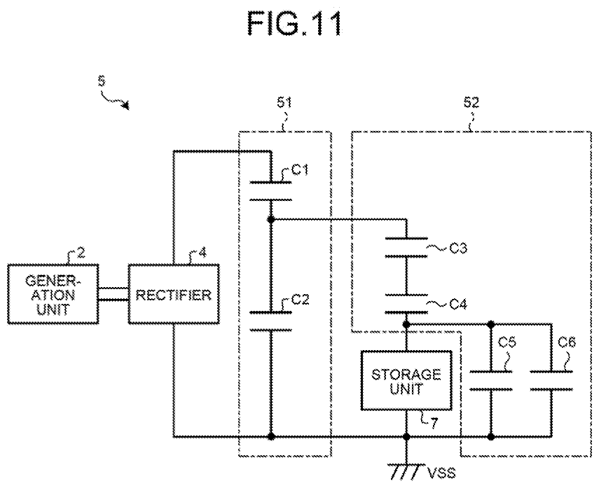

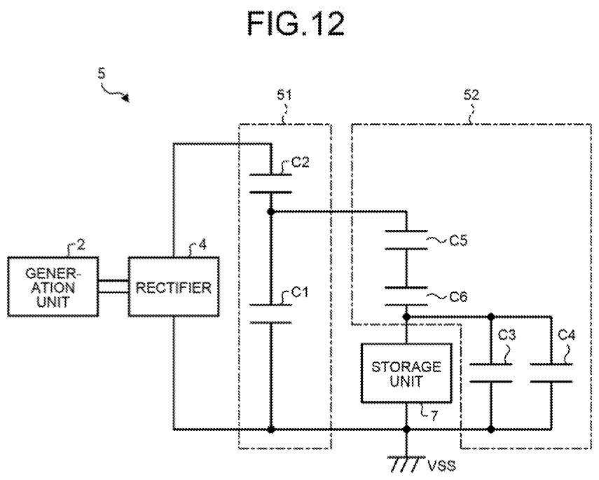

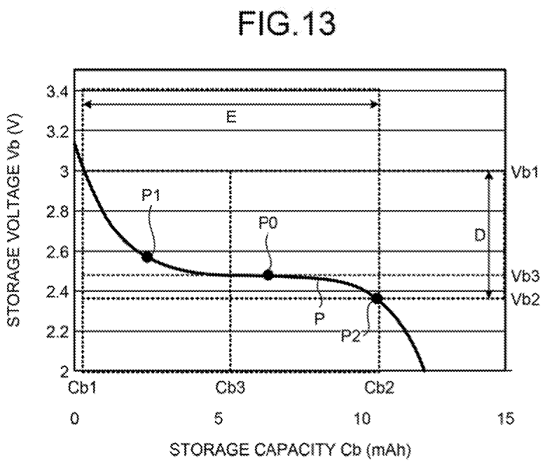

FIG. 1 is a diagram illustrating a portable watch according to the embodiment. FIG. 2 is a sectional view of the portable watch according to the embodiment. FIG. 3 is a block diagram of a power generation system according to the embodiment. FIG. 4 is a diagram illustrating a general configuration of a power generation unit. FIGS. 5A and 5B are diagrams for describing the generation operation of a generation main body. FIG. 6 is a graph illustrating the (averaged) relation between operating frequency of an energy generator and relative rotation rate of an electrostatic induction generator. FIG. 7 is a graph illustrating the relation between the operating frequency of the energy generator and the relative rotation rate of the electrostatic induction generator. FIG. 8 is a graph illustrating the relation between output voltage and output current of the power generation unit. FIG. 9 is a graph illustrating the relation between output voltage and power of the power generation unit. FIG. 10 is a block diagram of a voltage step-down unit. FIG. 11 is a diagram for describing the operation of the voltage step-down unit. FIG. 12 is another diagram for describing the operation of the voltage step-down unit. FIG. 13 is a graph illustrating a discharge curve of a power storage unit.

FIG. 2 includes an X-axis corresponding to the radial direction of the portable watch and a Z-axis corresponding to the vertical direction of the portable watch, where Z1 indicates the upward direction and Z2 indicates the downward direction.

FIG. 4 illustrates a rotating member 211 and a counter substrate 213 of a power generation unit 2, and a charging block 3. Some elements in the charging block 3 are not illustrated in FIG. 4.

FIGS. 6 and 7 are graphs illustrating mechanical natural frequency Tej of the power generation unit 2 and relative rotation rate K indicating relative amount of power generated by the power generation unit 2. FIG. 7 illustrates actual measured values of subjects and FIG. 6 illustrates the average value of all the subjects illustrated in FIG. 7. The relative rotation rate K in FIG. 6 is the ratio with the relative rotation rate K at the mechanical natural frequency Tej of 1 sec being 100.

FIG. 8 illustrates the relation between the output voltage and the output current of the power generation unit. The horizontal axis represents output voltage Vej of the power generation unit 2 and the vertical axis represents output current Iej of the power generation unit 2.

FIG. 9 illustrates the relation between the output voltage and the output power of the power generation unit. The horizontal axis represents the output voltage Vej of the power generation unit 2 and the vertical axis represents output power W that is the product of the output voltage Vej multiplied by the output current Iej.

FIGS. 11 and 12 are diagrams corresponding to FIG. 10 but excluding switches S1 to S22, and illustrate the operating state of step-down units 51 and 52.

FIG. 13 illustrates a discharge curve of the power storage unit. The horizontal axis represents storage capacity Cb and the vertical axis represents storage voltage Vb. This discharge curve P represents a change in the storage voltage Vb relative to the storage capacity Cb of a power storage unit 7.

A power generation system 1 according to the embodiment is installed in a portable watch 100. The portable watch 100 generates oscillations when a user 200 wears the portable watch 100 as illustrated in FIG. 1 and moves, or specifically, for example, walks. As illustrated in FIGS. 2 and 3, the portable watch 100 includes an outer case 110, a housing 120, a time display unit 130, a reduction mechanism 140, a motor 150, a controller 160, an energy generator 22, and the power generation system 1.

As illustrated in FIG. 2, the outer case 110 is the outermost casing of the portable watch 100, and is made of metal such as titanium or titanium alloy. The outer case 110 includes a main body 111, a watch crystal 112, and a back cover 113. The main body 111 has an annular shape and defines an accommodation space S. The main body 111 has openings in the vertical direction, one of which is an upper opening closed by the watch crystal 112 made of transparent material such as glass or transparent resin with a packing 114 being interposed, and the other one of which is a lower opening closed by the back cover 113 made of the same material as that of the outer case 110. This structure makes the accommodation space S closed. The accommodation space S accommodates the housing 120, the time display unit 130, the reduction mechanism 140, the motor 150, the controller 160, the energy generator 22, and the power generation system 1.

The housing 120 fixes the components accommodated in the accommodation space S. As illustrated in FIG. 2, the housing 120 has a main plate 121 and a bridge 122. The housing 120 according to the present embodiment is made of metal or resin and is disposed in the accommodation space S with the main plate 121 being at the lower side and the bridge 122 being at the upper side. The main plate 121 and the bridge 122 face each other in the vertical direction.

The time display unit 130 displays watch inner time in user-recognizable form. As illustrated in FIGS. 1 and 2, the time display unit 130 according to the present embodiment is an analog display, but may be a digital display. The time display unit 130 includes a dial plate 131, a minute hand 132, and an hour hand 133. The dial plate 131 is formed in a disc shape and is fixed to the bridge 122. As illustrated in FIG. 1, the dial plate 131 has indices 131a. The indices 131a are used to display time in a user-recognizable form in association with the positions of the minute hand 132 and the hour hand 133 relative to the indices 131a. The indices 131a are equally angularly spaced in the circumferential direction on the dial plate 131. The hands 132 and 133 coaxially rotate about, for example, the center of the dial plate 131 on the upper side of the dial plate 131. The hands 132 and 133 are positioned relative to the indices 131a on the dial plate 131. The minute hand 132 points to the “minutes” of the displayed time and the hour hand 133 points to the “hour” of the displayed time. The hands 132 and 133 according to the present embodiment are formed such that the hour hand 133 is shorter than the minute hand 132 in the radial direction from the center of the dial plate 131. The time display unit 130 may include a second hand and a date display to indicate the “seconds” and the “date” of the displayed time.

As illustrated in FIGS. 2 and 3, the reduction mechanism 140 transmits driving force generated by the motor 150 to the hands 132 and 133 to rotate them. The reduction mechanism 140 according to the present embodiment is a reduction wheel train including a plurality of wheels rotatably supported relative to the bridge 122. The reduction mechanism 140 includes an input wheel (not illustrated) meshing with a wheel fixed to the shaft of the motor 150 and a minute-hand output wheel (not illustrated) meshing with a minute wheel (not illustrated). This structure turns the minute hand 132 in accordance with the revolution of the motor 150. The reduction mechanism 140 also includes an hour-hand output wheel (not illustrated) meshing with an hour wheel (not illustrated). This structure turns the hour hand 133 in accordance with the revolution of the motor 150. The reduction mechanism 140 has a certain minute-hand reduction ratio between the revolutions of the motor 150 and the revolutions of the minute wheel, and has a certain hour-hand reduction ratio between the revolutions of the motor 150 and the revolutions of the hour wheel. The minute-hand reduction ratio in the present embodiment is set such that the minute hand 132 turns once per 60 minutes and the hour-hand reduction ratio in the present embodiment is set such that the hour hand 133 turns once per 720 minutes.

As illustrated in FIGS. 2 and 3, the motor 150 turns the hands 132 and 133. The motor 150 according to the present embodiment is an electromagnetic motor such as a stepper motor. The motor 150 includes a stator, a rotor, and coils, which are not illustrated. The motor 150 is connected to the controller 160. Upon application of a driving pulse generated by the controller 160, the motor 150 generates an induced electromotive force and rotates the rotor carrying permanent magnets (not illustrated) relative to the stator by, for example, 180 degrees. In this manner, the motor 150 converts electric power into rotational force as the driving force. The motor 150 is driven by the power supplied from the power storage unit 7 upon application of a driving signal from the controller 160.

As illustrated in FIG. 3, the controller 160 controls the driving of the motor 150 and the charging of the power generation system 1. The controller 160 outputs a driving pulse to the motor 150 to rotate the minute hand 132 and the hour hand 133 in the forward direction (clockwise) based on the watch inner time kept by a timekeeping element (not illustrated) so that the time displayed by the minute hand 132 and the hour hand 133 corresponds to the watch inner time. The controller 160 according to the present embodiment is a control circuit (not illustrated) including circuits such as an oscillation circuit, a divider circuit, and a drive circuit. The oscillation circuit has a higher frequency accuracy than that of the oscillation circuit of a timing generator 8, which will be described later. The controller 160 is configured by electronic components mounted on a circuit board 181 fixed on the upper side of the main plate 121. To achieve required functions, the controller 160 has the same or substantially the same hardware configuration as that of a known microcomputer. The controller 160 is electrically connected to the timing generator 8 to control the timing generator 8. When, for example, the power storage unit 7 is overcharged, the controller 160 outputs a stop signal to the timing generator 8 to stop generation of the timing signal and stop the operation of a voltage step-down unit 5.

As illustrated in FIG. 3, the power generation system 1 includes the power generation unit 2 and the charging block 3. In the system, the power generation unit 2 generates power and the power storage unit 7, which will be described later, stores the output power of the power generation unit 2 through the charging block 3. The power generation unit 2 includes a generation main body 21 and the energy generator 22. To generate power, the power generation unit 2 rotates upon application of energy, or rotational force, generated by the energy generator 22 and transmitted through a speed-increasing mechanism including a first wheel 25 and a second wheel 27. The charging block 3 includes a rectifier 4, the voltage step-down unit 5, a reverse current blocking unit 6, the power storage unit 7, and the timing generator 8.

The energy generator 22 according to the present embodiment is like an oscillating weight of a mechanical watch that stores energy in the mainspring and operates in accordance with the movement of the user. The rotational energy of the energy generator 22 generated in accordance with the movement of the user is transmitted through the first wheel 25 and the second wheel 27 to the generation main body 21. Adjusting the diameter of the first wheel 25 and the second wheel 27 can change the rotation rate of the generation main body 21.

The generation main body 21 is an electrostatic induction generator including a rotating member 211, electrification films 212 provided on the rotating member 211, the counter substrate 213 facing the electrification films 212, and counter electrodes 214 and 215 facing the electrification films 212 and provided on the counter substrate 213. The rotational energy transmitted from the energy generator 22 rotates the rotating member 211, thereby moving the electrification films 212 relative to the counter electrodes 214 and 215 to convert the rotational energy into electric energy.

The rotating member 211 is fixed to a second shaft 26 at the axis of rotation and is rotatably supported relative to the counter substrate 213. The rotating member 211 is a disc-shaped member made of, for example, a silicon substrate, a glass epoxy substrate having an electrode surface to be electrified, or a substrate made of what is called a low-density material such as an aluminum plate.

The electrification films 212 are equally angularly spaced in the circumferential direction and radially extend about the second shaft 26. The electrification films 212 are thin layers made of electret material. The electrification films 212 are electrified to have the same polarity, which is negative in the present embodiment. Examples of the electret material include resin material such as CYTOP (registered trademark), high-polymer material such as polypropylene (PP), polyethylene terephthalate (PET), polyvinyl chloride (PVC), polystyrene (PS), polytetrafluoroethylene (PTFE), polyvinylidene difluoride (PVDF), and polyvinyl fluoride (PVF), and inorganic material such as silicon oxide (SiO₂) and silicon nitride (SiN). The rotating member 211 has cut-out portions 211a between adjacent electrification films 212 in the circumferential direction. The cut-out portions 211a are formed radially inward from the outer circumference of the rotating member 211. In other words, the rotating member 211 has independent portions provided with the electrification films 212 and separated by the cut-out portions 211a adjacent in the circumferential direction. Each independent portion functions as a wing.

Since the counter substrate 213 is fixed to the housing 120, the electrification films 212 of the generation main body 21 are rotatable relative to the counter substrate 213. The counter substrate 213 is, for example, a disc-shaped substrate made of a substrate material such as polyimide for a flexible printed circuit (FPC) substrate and a glass epoxy substrate. As illustrated in FIG. 2, the counter substrate 213 according to the present embodiment is fixed to the upper side of the main plate 121. The counter substrate 213 has the counter electrodes 214 and 215 on a surface, or on the upper surface, facing the rotating member 211 in the vertical direction. As illustrated in FIG. 4, the counter substrate 213 has a center insertion hole 213a in which the second shaft 26 is inserted. The counter substrate 213 and the circuit board 181 are formed as separate structures, but are not limited to this. The counter substrate 213 and the circuit board 181 may be formed as a unitary structure if the counter substrate 213 can be accurately positioned relative to the rotating member 211.

The counter electrodes 214 and 215 are alternately and equally angularly arranged in the circumferential direction, and radially extend about the insertion hole 213a of the counter substrate 213. The counter electrodes 214 and 215 are formed on the counter substrate 213 such that they overlap the electrification films 212 when seen in the vertical direction. The counter electrodes 214 and a wire 216 form an electrode array. The counter electrodes 215 and a wire 217 form another electrode array. The counter electrodes 214 as a single electrode array and the counter electrodes 215 as another single electrode array are electrically connected to the rectifier 4. The number and the width in the circumferential direction of the respective counter electrodes 214 and 215, and the electrification films 212 are the same.

Described next is power generation of the generation main body 21 with reference to FIGS. 5A and 5B.

The generation main body 21 alternates between the state illustrated in FIG. 5A and the state illustrated in FIG. 5B as the rotating member 211 rotates to move the electrification films 212 relative to the counter electrodes 214 and 215.

In FIG. 5A, the electrification films 212 are above the counter electrodes 214, where electrostatic induction occurs to develop a charge of polarity (in this case, positive) opposite to the polarity of the electrification films 212.

Rotation of the rotating member 211 shifts the state illustrated in FIG. 5A to the state illustrated in FIG. 5B.

In FIG. 5B, the electrification films 212 are above the counter electrodes 215, where electrostatic induction occurs to develop a charge of polarity (in this case, positive) opposite to the polarity of the electrification films 212.

Since no electrification films 212 are disposed above the counter electrodes 214, the electric charge stored in the counter electrodes 214 is discharged.

Rotation of the rotating member 211 shifts the state illustrated in FIG. 5B to the state illustrated in FIG. 5A again.

In FIG. 5A, the electrification films 212 are above the counter electrodes 214, where electrostatic induction occurs to develop a charge of polarity (in this case, positive) opposite to the polarity of the electrification films 212.

Since no electrification films 212 are disposed above the counter electrodes 215, the electric charge stored in the counter electrodes 215 is discharged.

As the rotating member 211 rotates, the counter electrodes 214 and 215 repeatedly store and release the electric charge, thereby generating power.

The energy generator 22 generates energy for use in electric power generation. The energy generator 22 according to the present embodiment is an oscillating weight that generates rotational energy as it oscillates. The oscillation is generated by the vibration of the portable watch 100 worn by a user 200 who is moving, or specifically, for example, walking.

The energy generator 22 is disposed below the main plate 121 and is fixed to a first shaft 23. The first shaft 23 is rotatably supported by a bearing 182 relative to the main plate 121.

The first shaft 23 protrudes from the main plate 121 toward the bridge 122, and its upper end is fixed to the first wheel 25. Since the first wheel 25 meshes with the second wheel 27 fixed to the second shaft 26, the rotation of the energy generator 22 rotates the second shaft 26. The first wheel 25 and the second wheel 27 configure the speed-increasing mechanism. This mechanism can adjust the ratio of the rotation rate of the energy generator 22 to the rotation rate of the rotating member 211 to a certain speed-increasing ratio.

The second shaft 26 is fixed in the vertical direction by bearings 183 that rotatably support the upper and lower ends of the second shaft 26 relative to the bridge 122 and the main plate 121, respectively. The second shaft 26 is fastened to the rotating member 211 of the generation main body 21.

The speed-increasing mechanism is not limited to a wheel train mechanism, and may be any mechanisms such as a cam clutch mechanism and a belt mechanism if the mechanism can rotate the rotating member 211 at a greater rotation rate than that of the energy generator 22. The energy generator 22 may rotate the rotating member 211 using the rotation in one of two rotational directions. Alternatively, the energy generator 22 may rotate the rotating member 211 using the rotation in both directions by using a conversion clutch mechanism (not illustrated).

Described next is a rated generation state of the power generation unit 2.

The power generation unit 2 generates power most efficiently in the rated generation state. The rated generation state is determined based on mechanical natural frequency Tej of the power generation unit 2.

The mechanical natural frequency Tej is a frequency at which the rotating member 211 is most rotatable relative to the counter substrate 213 upon application of external vibration. The mechanical natural frequency Tej is determined by an expression Tej=2·π·√(m·g·1).

In this expression, ja is a load (including rotational load of the generation main body 21) of the energy generator 22 to the rotating member 211. In the present embodiment, the load includes, as parameters, the speed-increasing ratio and the moment of inertia of rotatable parts such as the first wheel 25, the second wheel 27, and the rotating member 211.

In the expression, m is the mass of the energy generator 22 and 1 is the distance from the axis of rotation of the energy generator 22 to the center of gravity of the energy generator 22.

In other words, m·g·1 represents the gravitational torque acting on the energy generator 22.

FIGS. 6 and 7 illustrate the results of experiments on the power generation unit 2 having a different mechanical natural frequency Tej. The experiments were conducted by four subjects A to D wearing the portable watch 100 to study the change in the relative rotation rate K in accordance with the change in the mechanical natural frequency Tej while the subjects A to D are moving. FIG. 7 illustrates actual measured values of the subjects and FIG. 6 illustrates the averaged value of the subjects in FIG. 7.

As illustrated in FIGS. 6 and 7, the relative rotation rate K of the rotating member 211 relative to the counter substrate 213 changes with the mechanical natural frequency Tej.

Although illustrated in FIGS. 6 and 7, the range of the mechanical natural frequency Tej smaller than 0.5 sec makes it challenging to design the energy generator 22 as a speed-increasing mechanism included in a wrist-worn portable watch 100, or makes it difficult to keep the relative rotation rate K equally high for the respective subject users 200. Due to such instabilities, the range smaller than 0.5 sec is not considered in setting the mechanical natural frequency Tej and thus regarded as reference.

As illustrated in FIGS. 6 and 7, graphs QA to QD of the respective subjects A to D and an average graph Q have the peak of the relative rotation rate K between 0.5 to 1.0 sec of the mechanical natural frequency Tej. In other words, the energy generator 22 resonates well when the user 200 wearing the portable watch 100 moves.

As illustrated in FIG. 7, the relative rotation rate K of most of the subjects A to D increases with the mechanical natural frequency Tej when it is higher than 0.6 sec, and decreases when the mechanical natural frequency Tej exceeds 1.2 sec. In this regard, it is preferable that the mechanical natural frequency Tej is set to 0.6 sec or higher and 1.2 sec or lower including the peak relative rotation rate K. As illustrated in FIG. 7, the relative rotation rate K of all the subjects A to D increases when the mechanical natural frequency Tej is 0.8 sec or higher compared to the case of 0.6 sec. More specifically, the relative rotation rate K of all the subjects A to D has the peak when the mechanical natural frequency Tej is 1.0 sec or lower. In this regard, it is more preferable that the mechanical natural frequency Tej is set to 0.8 sec or higher and 1.0 sec or lower including the peak relative rotation rate K.

As indicated by the average graph Q in FIG. 6, the average peak relative rotation rate of all the subjects A to D comes at the mechanical natural frequency Tej of 0.94 sec. In this regard, it is far more preferable that the mechanical natural frequency Tej is set to 0.94 sec corresponding to the peak relative rotation rate K.

In other words, the rated generation state is such that the frequency of the portable watch 100 generated by the movement of a user 200 wearing the portable watch 100 coincides with the mechanical natural frequency Tej set for the power generation unit 2.

The output voltage Vej of the power generation unit 2 according to the present embodiment in the rated generation state is set based on the output voltage Vej and the power W of the power generation unit 2 at the mechanical natural frequency Tej.

As indicated by graphs JA to JC in FIG. 8, the power generation unit 2 generates a larger output voltage Vej and a larger output current Iej as the relative rotation rate of the rotating member 211 relative to the counter substrate 213 increases (the relative rotation rate is larger in the order of the graphs JA, JB, and JC). The output voltage Vej is largest in an unloaded condition.

As indicated by graphs JA to JC in FIG. 9, which illustrate the relation between the output power W and the output voltage Vej of the power generation unit 2, the peak output power W does not correspond to the output voltage Vej in the unloaded condition of the power generation unit 2.

The peak output power W of the graphs JA to JC is located at the respective center corresponding to respective power-peak output voltages Vja to Vjc. The output voltages Vja to Vjc corresponding to the respective peak output power is greater as the relative rotation rate increases (the relative rotation rate is larger in the order of the graphs JA, JB, and JC).

In other words, the power generation unit 2 is most energy-efficient when having the mechanical natural frequency Tej corresponding to the rated generation state in which the power generation unit 2 can generate power most efficiently, and when outputting the output voltage Vej corresponding to the power-peak output voltages Vja to Vjc in a state connected to the power storage unit 3.

Let the most energy-efficient output voltage be a power-peak output voltage Vejp.

As illustrated in FIGS. 3 and 4, the rectifier 4 is electrically connected to the power generation unit 2 to rectify the output of the power generation unit 2. The rectifier 4 according to the present embodiment is a rectifier circuit that converts alternating current output from the generation main body 21 to direct current and is, for example, a bridge circuit including four diodes. The rectifier 4 is configured by electronic components mounted on the circuit board 181.

As illustrated in FIGS. 3 and 10, the voltage step-down unit 5 is electrically connected to the power generation unit 2 and the power storage unit 7 to reduce the output voltage Vej of the power generation unit 2 to an input voltage of the power storage unit 7, or in other words, to a step-down voltage Vsb. The voltage step-down unit 5 according to the present embodiment is electrically connected to the power generation unit 2 via the rectifier 4 and to the power storage unit 7 via the reverse current blocking unit 6. The voltage step-down unit 5 has a step-down ratio X larger than 1. The voltage step-down unit 5 divides the output voltage Vej by the step-down ratio X to provide a step-down voltage Vsb. In the present embodiment, the step-down ratio is set to six (X=6). The voltage step-down unit 5 is a step-down circuit configured to convert the input voltage input to the voltage step-down unit 5, or the output voltage Vej, to a step-down voltage by switching a plurality of capacitors C1 to C6 mounted on the circuit board 181 between a series-connected state and a parallel-connected state.

The voltage step-down unit 5 includes a first step-down unit 51 and a second step-down unit 52. The first step-down unit 51 reduces the output voltage Vej by half and includes two parallel-connected capacitors C1 and C2 that are electrically connected to the rectifier 4. The capacitor C1 is connected to switches S1 and S2, such as MOS transistors, that are disposed in the respective paths from the rectifier 4, and connected to switches S3 and S4 that are disposed in the respective paths to the second step-down unit 52.

The capacitor C2 is connected to switches S5 and S6, such as MOS transistors, that are disposed in the respective paths from the rectifier 4, and connected to switches S7 and S8 that are disposed in the respective paths to the second step-down unit 52.

The second step-down unit 52 reduces the output voltage of the first step-down unit 51 to one-third, and includes parallel-connected first and second capacitor groups (including, respectively, capacitors C3 and C4, and capacitors C5 and C6) that are electrically connected to the first step-down unit 51.

The capacitor C3 is connected to a switch S9 disposed in a path from the first step-down unit 51 and to a switch S10 disposed in a path to the ground, and connected to a switch S11 disposed in a path to the power storage unit 7.

The capacitor C4 is connected to a switch S12 disposed in a path from one side of the capacitor C3 and to a switch S13 disposed in a path to the ground, and connected to switches S14 and S15 that are disposed in the respective paths to the power storage unit 7.

The capacitor C5 is connected to a switch S16 disposed in a path from the first step-down unit and to a switch S17 disposed in a path to the ground, and connected to a switch S18 disposed in a path to the power storage unit 7. The capacitor C6 is connected to a switch S19 disposed in a path from one side of the capacitor C5 and to a switch S20 disposed in a path to the ground, and connected to switches S21 and S22 that are disposed in the respective paths to the power storage unit 7.

The first step-down unit 51 reduces the output voltage Vej by half and the second step-down unit 52 reduces the halved voltage to one-third, and thus, the voltage step-down unit 5 reduces the output voltage Vej to one-sixth. The switches S1 to S22 are turned on or off based on a timing signal T generated by the timing generator 8.

Described next is the operation of the voltage step-down unit 5 based on the timing signal T. The timing signal T includes a timing signal T1 for controlling the on/off state of the switches S1, S4, S6, S7, S9, S12, S15, S17, S18, S20, and S21 (hereinafter simply referred to as “the switches S1 to S21”) and a timing signal T2 for controlling the on/off state of the switches S2, S3, S5, S8, S10, S11, S13, S14, S16, S19, and S22 (hereinafter simply referred to as “the switches S2 to S22”). The timing signal T is used to switch the voltage step-down unit 5 between a first step-down state and a second step-down state.

In the first step-down state, the timing signal T1 is on and the timing signal T2 is off and thus the switches S1 to S21 are on and the switches S2 to S22 are off. As illustrated in FIG. 11, the capacitor C1 is discharged and the capacitor C2 is charged in the first step-down unit 51, and the capacitors C5 and C6 are discharged and the capacitors C3 and C4 are charged in the second step-down unit 52.

In the second step-down state, the timing signal T1 is off and the timing signal T2 is on and thus the switches S1 to S21 are off and the switches S2 to S22 are on. As illustrated in FIG. 12, the capacitor C1 is charged and the capacitor C2 is discharged in the first step-down unit 51, and the capacitors C5 and C6 are charged and the capacitors C3 and C4 are discharged in the second step-down unit 52.

The reverse current blocking unit 6 is electrically connected to the voltage step-down unit 5 to prevent reverse current from the power storage unit 7 to the voltage step-down unit 5, which may occur when the storage voltage Vb of the power storage unit 7 is higher than the output voltage of the voltage step-down unit 5, or higher than the step-down voltage Vsb. The reverse current blocking unit 6 according to the present embodiment is, for example, a reverse current blocking diode mounted on the circuit board 181 or included in an integrated circuit (IC) including the voltage step-down unit 5.

The power storage unit 7 stores therein the output of at least the power generation unit 2. As illustrated in FIG. 3, the power storage unit 7 is electrically connected to the reverse current blocking unit 6.

The power storage unit 7 according to the present embodiment is a rechargeable secondary battery and is fixed to the bridge 122. The power storage unit 7 has characteristics of the discharge curve P illustrated in FIG. 13 representing the relation between the storage voltage Vb (V) and the storage capacity Cb (mAh) of the power storage unit 7.

The discharge curve P indicates a change in the storage voltage Vb (V) relative to the storage capacity Cb (mAh). Although there may be a slight difference depending on the type or capacity of the secondary battery used as the power storage unit 7, the discharge curve P has a steep-slope region, a gentle-slope region, and another steep-slope region from a higher side to a lower side of the storage capacity Cb.

The discharge curve P has an inflection point P0 in the gentle-slope region. The inflection point P0 is obtained by double differentiation. The discharge curve P has a turning point P1 corresponding to a first turning point having the maximum curvature at a high-voltage side relative to the inflection point P0. The turning point P1 is located at the boundary between the gentle-slope region and a steep-slope region. The discharge curve P has a turning point P2 corresponding to a second turning point having the maximum curvature at a low-voltage side relative to the inflection point P0. The turning point P2 is located at the boundary between the gentle-slope region and another steep-slope region.

The portable watch 100 has a working voltage range D that is a voltage range of the power storage unit 7 available to the portable watch 100. The working voltage range D has an upper-limit working voltage Vb1 and a lower-limit working voltage Vb2 (Vb1>Vb2).

The upper-limit working voltage Vb1 is a threshold of the storage voltage Vb above which, when charged, the power storage unit 7 is determined to be overcharged. The upper-limit working voltage Vb1 is, for example, 3.0 V. If the power storage unit 7 is charged to a voltage at or above the threshold, above which the power storage unit 7 is determined to be overcharged, the voltage step-down unit 5 stops operating so that the power storage unit 7 will not be charged to a voltage at or above the upper-limit working voltage Vb1.

The lower-limit working voltage Vb2 is, for example, a voltage set independent of the generation state of the power generation unit 2. The lower-limit working voltage Vb2 is, for example, 2.39 V.

A midpoint storage voltage Vb3 is a battery voltage corresponding to a midpoint storage capacity Cb3 that is the midpoint of a storage capacity range E corresponding to the working voltage range D of the storage voltage Vb. The midpoint storage voltage Vb3 is the most available battery voltage in using the portable watch 100. It is preferable that the midpoint storage voltage Vb3 is between the turning points P1 and P2 and close to the inflection point P0, and is, for example, 2.5 V.

The timing generator 8 generates a timing signal for use in switching the capacitors C1 to C6 in the voltage step-down unit 5 between the series-connected state and the parallel-connected state. The timing generator 8 is electrically connected to the rectifier 4 and to the voltage step-down unit 5. As illustrated in FIG. 3, the timing generator 8 includes a constant voltage circuit 81 and an oscillation circuit 82, and is mounted on the circuit board 181.

When the rectifier 4 receives an output of the power generation unit 2 and the timing generator 8 receives an output of the rectifier 4, the constant voltage circuit 81 reduces the output voltage Vej of the power generation unit 2 to a certain low voltage.

The constant voltage circuit 81 supplies the certain low voltage to the oscillation circuit 82 and drives the oscillation circuit 82 at this voltage, which leads to a lower current consumption of the oscillation circuit 82.

The oscillation circuit 82 generates an oscillation signal upon an output of the constant voltage circuit 81.

The timing generator 8 generates the timing signal T based on the oscillation signal generated by the oscillation circuit 82 and outputs the timing signal T to the voltage step-down unit 5. The timing generator 8 generates the timing signal T including the timing signals T1 and T2 that alternates between on and off in accordance with switching frequency based on the oscillation signal.

Accordingly, the voltage step-down unit 5 alternates between the first step-down state and the second step-down state in accordance with the switching frequency when the power generation unit 2 is generating power, and reduces the output voltage Vej of the power generation unit 2 to the step-down voltage Vsb for the power storage unit 7.

Described next is the operation of the power generation system 1. When a user 200 wearing the portable watch 100 moves, the portable watch 100 vibrates. As illustrated in FIG. 3, this vibration oscillates the energy generator 22 and then rotates the rotating member 211. Accordingly, the electrification films 212 rotate relative to the counter electrodes 214 and 215 and the generation main body 21 generates power.

The power generated by the generation main body 21, or the output of the power generation unit 2, is rectified from alternating current to direct current by the rectifier 4 in the charging block 3. The output of the power generation unit 2 is also input to the timing generator 8, at which the timing signal T is generated and output to the voltage step-down unit 5. The voltage step-down unit 5 then alternates between the first step-down state and the second step-down state.

The output voltage Vej of the power generation unit 2 is reduced at the voltage step-down unit 5 based on the step-down ratio X. In the present embodiment, the output voltage Vej is reduced to one-sixth and the resulting voltage is used as the step-down voltage Vsb for the power storage unit 7, which is electrically connected to the voltage step-down unit 5.

Since the reverse current blocking unit 6 is provided between the voltage step-down unit 5 and the power storage unit 7, the quotient of the output voltage Vej divided by the step-down ratio X is not exactly the step-down voltage Vsb. However, in the present embodiment, the quotient of the output voltage Vej divided by the step-down ratio X is used as the step-down voltage Vsb.

The output of the power generation unit 2, or the output voltage Vej, is reduced at the voltage step-down unit 5 to the step-down voltage Vsb and then input to the power storage unit 7 to charge the power storage unit 7.

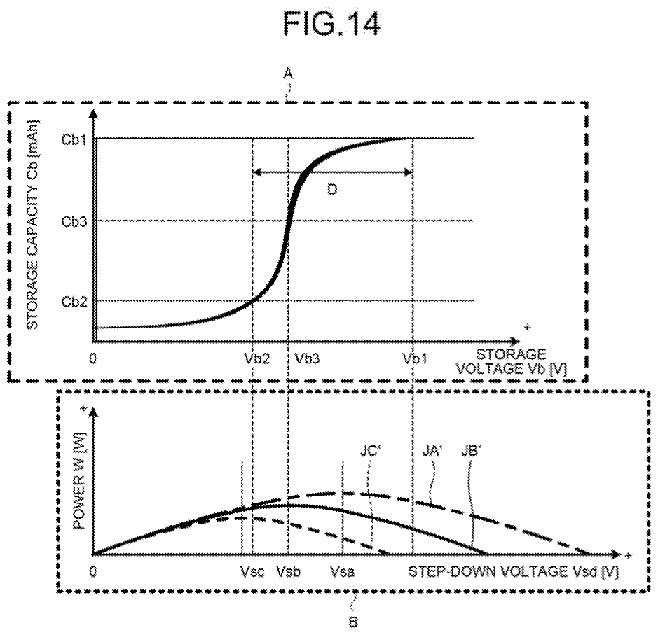

FIG. 14 illustrates the relation between the input voltage of the power storage unit and the output voltage of the voltage step-down unit, and includes a region A and a region B. The region A illustrates a discharge curve of the power storage unit with the axis of the storage voltage Vb and the axis of the storage capacity Cb in FIG. 13 being interchanged. The region B illustrates graphs of step-down voltages reduced at the voltage step-down unit 5 corresponding to the graphs in FIG. 9 illustrating the relation between the output voltage Vej and the power W of the power generation unit 2. Graphs JA′, JB′, and JC′ indicate outputs of the voltage step-down unit 5 obtained by dividing the output voltages Vej indicated by the graphs JA, JB, and JC in FIG. 9 by the step-down ratio X. Vsa, Vsb, and Vsc are step-down voltages Vsd corresponding to the respective peak output power W of the graphs JA′, JB′, and JC′.

In the present embodiment, the power storage unit 7 has the midpoint storage voltage Vb3 that coincides with the power-peak step-down voltage Vsb. Since the most energy-efficient voltage (Vsb) of the power generation unit 2 in the rated generation state coincides with the battery voltage (Vb3) that is the most available voltage for use of the portable watch 100, the portable watch 100 can generate power more efficiently.

As indicated by the graph JA′ in FIG. 14 corresponding to high relative rotation rate (high-power generation state), the step-down voltage Vsd of the step-down unit 5 exceeds the upper-limit working voltage Vb1. Thus, the power storage unit 7 can be charged to the upper-limit working voltage Vb1 of the working voltage range D, although charge efficiency is low compared to the case of using the midpoint storage voltage Vb3.

As indicated by the graph JC′ in FIG. 14 corresponding to low relative rotation rate (low-power generation state), the step-down voltage Vsd of the step-down unit 5 exceeds the lower-limit working voltage Vb2. Thus, the power storage unit 7 can be charged to the lower-limit working voltage Vb2 of the working voltage range D, although charge efficiency is low compared to the case of using the midpoint storage voltage Vb3. This configuration enables charging even if generation rate of the power generation unit 2 fluctuates.

It is desirable that the power-peak step-down voltage Vsb of the graph JB′ coincides with the midpoint storage voltage Vb3 as described above. However, if the step-down voltage falls in the gentle-slope range of the discharge curve P between the turning points P1 and P2 as illustrated in FIG. 13, the step-down voltage can be close to the midpoint storage voltage Vb3 and the charge efficiency can be good.

Described next are parameters with specific numerical values.

According to the result in FIG. 6, it is preferable that the mechanical natural frequency Tej of the power generation unit 2 is 0.94 sec. When the speed-increasing mechanism has the speed-increasing ratio of 180, the rotation rate of the rotating member 211 in the rated generation state is about 190 rps.

The relation between the output voltage Vej and the power W of the power generation unit 2 with the rotating member 211 rotating at the rotation rate of 190 rps has the characteristics illustrated in FIG. 9. Let the power-peak output voltage Vjb with the rotating member 211 rotating at 190 rps be 15 V and the step-down ratio X of the voltage step-down unit 5 be 6, Vsb in FIG. 14 is 2.5 V.

The power storage unit 7 has the characteristics illustrated in FIG. 13, where Vb1 is 3.0 V, Vb2 is 2.39 V, and Vb3 is 2.5 V. In this regard, the power-peak step-down voltage Vsb of the graph JB′ can coincide with the midpoint storage voltage Vb3.

Let the storage voltage Vb in FIG. 13 in the gentle-slope region between the turning points P1 and P2 and including the inflection point P0 be storage voltage Vbe. The power generation unit 2 and the charging block 3 of the power generation system 1 are configured such that the step-down voltage Vsb coincides with the storage voltage Vbe. In the power generation unit 2 according to the present embodiment, the speed-increasing ratio of the speed-increasing mechanism is set such that the step-down voltage Vsb coincides with the storage voltage Vbe. In addition to the speed-increasing ratio of the speed-increasing mechanism, examples of adjustable parameters for setting the step-down voltage Vsd to coincide with the storage voltage Vbe include the step-down ratio X of the voltage step-down unit 5, the moment of inertia of the rotatable parts of the speed-increasing mechanism, the moment of inertia of the energy generator 22, the number of electrodes in the power generation unit 2, and the distance between the electrification films 212, and the counter electrodes 214 and 215. Since the moment of inertia of the energy generator 22 is attributable to the generation rate of the power generation unit 2, it is preferable that the other parameters are in preference to this moment of inertia in adjusting the parameters.

The power generation system 1 and the portable watch 100 according to the embodiment above are configured such that the step-down voltage Vsb coincides with the storage voltage Vbe in the gentle-sloping range between the turning points P1 and P2. Since the step-down voltage Vsb is set based on the power-peak output voltage Vejp, the power generation unit 2 generates power efficiently. As illustrated in FIG. 13, the sloping region between the turning points P1 and P2 is in the working range D of the storage voltage Vb. This region is, in other words, a region in which the power storage unit 7 can be charged or discharged during use of the device including the power generation system 1, or in this case, the portable watch 100. The sloping region between the turning points P1 and P2 has less voltage variation of the storage voltage Vb relative to the change in the storage capacity Cb. The storage voltage Vb does not vary significantly with the change in the storage capacity Cb, but varies, for example, only by several tens of mV to a hundred and several tens of mV, thereby keeping, to some extent, a constant storage voltage Vb. Since the step-down voltage Vsb is set to coincide with the storage voltage Vbe in the sloping region between the turning points P1 and P2, the output of the power generation unit 2 can be stored in the power storage unit 7 efficiently via the voltage step-down unit 5 even if, for example, generation rate of the power generation unit 2 or the storage voltage Vb varies during daily use.

The power generation system 1 and the portable watch 100 according to the embodiment above may be configured such that the step-down voltage Vsb coincides with the midpoint storage voltage Vb3 (=Vbe). The midpoint storage voltage Vb3 is a storage voltage Vb corresponding to the midpoint storage capacity Cb3 that is the midpoint of the storage capacity range E (between the upper-limit storage capacity Cb1 and the lower-limit storage capacity Cb2 as illustrated in FIG. 13) corresponding to the working voltage range D. In this case, the step-down voltage Vsb coincides with the midpoint storage voltage Vb3 attributable to the working voltage range D of the storage voltage Vb.

The power-peak step-down voltage Vsb, which varies with the temperature, does not vary significantly in normal service temperatures (−10 to 60° C.) of the portable watch 100. To more efficiently store the output power of the power generation unit 2 in the power storage unit 7 via the voltage step-down unit 5, it is preferable that the power generation system 1 and the portable watch 100 set the step-down voltage Vsb to coincide with the storage voltage Vbe in a temperature range from the ambient temperature to user temperatures (25 to 37° C.).

The power generation system 1 according to the embodiment above is installed in the portable watch 100, but is not limited to this. The power generation system 1 may be installed in any portable devices, such as smartphones, tablets, and wearable devices, including electrostatic induction generators that generate power by oscillations generated in accordance with the movement, such as walking, of users wearing the devices.

The power generation system and the portable watch according to the present embodiment are configured such that the step-down voltage coincides with the storage voltage in the rated generation state of the power generation unit. The step-down voltage is set based on the storage voltage corresponding to the region between the first turning point and the second turning point on the discharge curve. The first turning point has the maximum curvature at a high-voltage side relative to the inflection point of the discharge curve and the second turning point has the maximum curvature at a low-voltage side relative to the inflection point. This configuration can efficiently store the output power of the power generation unit in the power storage unit via the voltage step-down unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power generation system comprising:
a power generation unit including a generation main body that has an electrification film and a counter electrode rotating relative to each other to generate power, and the energy generator that generates energy for rotating the electrification film and the counter electrode relative to each other;
a power storage unit configured to store output power of at least the power generation unit; and
a voltage step-down unit electrically connected to the power generation unit and the power storage unit and configured to reduce output voltage of the power generation unit to a step-down voltage, wherein the power storage unit has a discharge curve relative
to storage voltage and storage capacity, the discharge curve having
an inflection point,
a first turning point having maximum curvature at a high-voltage side relative to the inflection point, and
a second turning point having maximum curvature at a low-voltage side relative to the inflection point, and
the step-down voltage obtained by dividing the output voltage of the power generation unit in a rated generation state by a step-down ratio of the voltage step-down unit coincides with storage voltage corresponding to a region between the first turning point and the second turning point of the power storage unit.

2. The power generation system according to claim 1, wherein
the rated generation state is a state in which the power generation unit is operating at mechanical natural frequency of the power generation unit.

3. The power generation system according to claim 2, wherein
the mechanical natural frequency is 0.6 to 1.2 seconds.

4. The power generation system according to claim 1, wherein
the step-down voltage coincides with a midpoint storage voltage that is the storage voltage corresponding to a midpoint storage capacity at a midpoint of a storage capacity range corresponding to a working voltage range in which output of the power storage unit is available.

5. A portable watch comprising:
the power generation system according to claim 1; and
a time display unit configured to display time using output of the power storage unit.
